(19) United States
(12) Patent Application Publication
(10) Pub. No.: US 2006/0205258 A1
(43) Pub. Date: Sep. 14, 2006

(54) Top-loading card adapter

(75) Inventors: Jong-Won Cho, Seoul (KR); Tae-Wan Kim, Seoul (KR)

Correspondence Address: Richard P. Berg;Ladas & Parry, Suite 2100, 5670 Wilshire Boulevard, Los Angeles, CA, 90036, US

(73) Assignee: MAKUS, Inc.

(21) Appl. No.: 11/122,954

(22) Filed: May 4, 2005

(30) Foreign Application Priority Data
Mar. 8, 2005 (KR) 10-2005-0019028

(51) Int. Cl. H01R 13/62

(52) U.S. Cl. 439/326

(57) ABSTRACT

There is provided a card adapter including: a printed circuit board that is provided with a connector connected to an external data processing apparatus at one end thereof; a housing for accommodating the printed circuit board therein, and for exposing and fixing the connector at one side thereof; contact elements which are arranged adjacent to an end opposite to the side at which the connector of the printed circuit board is provided, and are electrically connected with a circuit device of the printed circuit board; and a card holder which is fixed adjacent to the contact elements such that the card is inserted into, and fixed to, the holder to be electrically contacted with the contact elements. The housing has an opening at the upper side corresponding to the card holder such that the card can be inserted or separated through the opening

### BACKGROUND OF THE INVENTION

1. Field of the Invention

The present invention relates to a card adapter, and more particularly, to a top-loading card adapter on which a small-sized chip type smart card is loaded at the upper side of a module to be connected to a connector of a data processing apparatus standardized according to the PCMCIA (Personal Computer Memory Card International Association) standard.

2. Description of the Related Art

Generally, a card adapter connects a standardized smart card to electronic communication equipment such that information stored in the circuit device of the smart card can be used in user authentication, global roaming, and electronic commerce.

The smart card is also called an IC (Integrated Circuit) card and has the same shape as a credit card standardized by the ISO (International Standard Organization). The smart card has a size of 54 mm width×86 mm length×0.76 mm thickness and is composed of a connecting terminal forming the circuit device, an IC chip, and a plastic card.

The smart card is divided into a memory smart card in which a memory or a protective device is embedded, a microprocessor built-in smart card which can perform enhanced functions, such as decision, operation, and data protection in addition to the memory, and an interactive smart card in which a memory, an I/O protocol, and an application program are embedded to bidirectionally transmit the information.

Hereinafter, an example of using the smart card will be described. A digital broadcasting provider provides a specific content through a satellite, a cable, or a ground wave and a user purchases the smart card, in which user authentication information is stored from the digital broadcasting provider, for a predetermined fee. The user receives a digital broadcasting (video/audio) signal in a compressed MPEG-2 form and performs a user authentication process through a set-top box which then transmits the signal to a display device such as a television to use the content.

A card adapter is used in transmitting the authentication information stored in the circuit device of the smart card to the connector of the set-top box.

Generally, the card adapter has an adapter system which connects the smart card to the connector of an electronic equipment, such as the set-top box, standardized according to the PCMCIA standard.

A conventional card adapter includes a slide-in slit for accommodating the standardized smart card which is communicated with an inner accommodating channel at one end thereof, a plug-in card housing in which a connector is arranged at the other end thereof, and a printed circuit board which is electrically connected to the connector, is extended in parallel with the accommodating channel, and has a contact element contacted to the circuit device of the smart card, as disclosed in European Patent No. 0735507 and International Publication No. WO03/03655.

However, since the smart card having the credit card shape is inserted into the inner accommodating channel through the slide-in slit formed at the front surface in the conventional card adapter, the smart card can not be fully inserted into the inner accommodating channel. Accordingly, a normal operation may not be performed or malfunction due to contact failure may occur.

Also, since the smart card is inserted into the inner accommodating channel through the slide-in slit formed at the front surface in the conventional card adapter, the smart card is easily separated from the module and thus can be lost or damaged.

Further, since the location of the smart card is fixed in the conventional card adapter, the location of the contact element for electrical connection is limited and thus the circuit arrangement of the printed circuit board can not be freely designed and the components can not be freely arranged.

Accordingly, since heating components, including a CPU (Central Processing unit), can not be freely arranged at a location in which the cooling is easily performed when designing the circuit arrangement of the printed circuit board, components can be damaged due to heat.

Moreover, since most of the inside of the housing, of which the width and height are limited according to the standard of the PCMCIA, is used as the accommodating channel for inserting the smart card, the sizes of the inner components are more limited.

### SUMMARY OF THE INVENTION

An object of the present invention is to provide a top-loading card adapter on which a small-sized chip type smart card is loaded at the upper side of a module to be connected to a connector of a data processing apparatus standardized according to the PCMCIA (Personal Computer Memory Card International Association) standard.

Another object of the present invention is to provide a top-loading card adapter which can prevent the loss and damage of the card due to the separation of the card and adaptor, and can prevent malfunction due to contact failure by inserting and fixing a small-sized chip type smart card into the module of a card adapter.

A further object of the present invention is to provide a top-loading card adapter that can more freely set the location of the contact elements corresponding to a small-sized chip type smart card such that the circuit device of the printed circuit board and the components can be freely arranged.

A still further object of the present invention is to provide a top-loading card adapter which can reduce an inner space for accommodating a small-sized chip type smart card in the housing, so that the components embedded therein can be freely selected.

The present invention provides a card adapter including: a printed circuit board which is provided with a connector connected to an external data processing apparatus at one end thereof; a housing for accommodating the printed circuit board therein and exposing and fixing the connector at one side thereof; contact elements that are arranged adjacent to an end opposite to the side at which the connector of the printed circuit board is provided and are electrically connected with a circuit device of the printed circuit board; and a card holder that is fixed adjacent to the contact elements such that the card is inserted into, and fixed to be electrically contacted with, the contact elements, wherein the housing has an opening at the upper side corresponding to the card holder such that the card can be inserted or separated through the opening.

Preferably, the card holder is formed with a slide-in slit and is rotatably hinge-coupled to the printed circuit board at one side of the contact elements, the housing comprises a door for opening and closing the opening, and the door is hinge-coupled to the housing.

Moreover, the card comprises a SIM (Subscriber Identification Module) card, the connector and the housing conform to the PCMCIA (Personal Computer Memory Card International Association) standard, and the housing is integrally formed by molding the outside of the printed circuit board.

Preferably, the contact elements are formed on an insulating substrate, which is formed independent of the printed circuit board, and the card holder is fixed on the insulating substrate.

Also, the card holder comprises at least a pair of guide projections formed along both sides that are opposed to each other through the contact elements on the printed circuit board.

Furthermore, the card holder is independently and rotatably hinge-coupled to the axis to which the door is hinge-coupled, and the card holder is link-coupled such that it is opened together with the door with a constant phase difference.

Also, the door may be integrally formed with the card holder at the inner side thereof, and the door may be coupled to slidingly open and close the opening of the housing.

Moreover, the housing includes a ventilation hole, which is formed at the side opposite to the side to which the connector is fixed, and a CPU (Central Processing Unit) is mounted on the printed circuit board adjacent to the side opposite to the side at which the connector is formed.

### BRIEF DESCRIPTION OF THE DRAWINGS

The above and other features and advantages of the present invention will become more apparent by describing in detail exemplary embodiments thereof with reference to the attached drawings, in which:

FIG. 1 is a perspective view of a top-loading card adapter according to a first embodiment of the present invention;

FIG. 2 is an exploded perspective view of the top-loading card adapter according to the first embodiment of the present invention;

FIG. 3 is a perspective view of a unit assembly combining a card holder and an insulating substrate on which contact elements are formed in a top-loading card adapter according to a second embodiment of the present invention;

FIG. 4 is a plan view of an insulating substrate on which contact elements and a card holder are integrally formed in a top-loading card adapter according to a third embodiment of the present invention;

FIG. 5 is a partial side view of a top-loading card adapter according to a fourth embodiment of the present invention;

FIG. 6 is a partial side view of a top-loading card adapter according to a fifth embodiment of the present invention;

FIG. 7 is a perspective view of a top-loading card adapter according to a sixth embodiment of the present invention; and

FIG. 8 is a perspective view of a modification of a housing in the top-loading card adapter according to the first embodiment of the present invention.

### DETAILED DESCRIPTION OF THE EMBODIMENTS

The preferred embodiment of the present invention will now be described more fully with reference to the accompanying drawings.

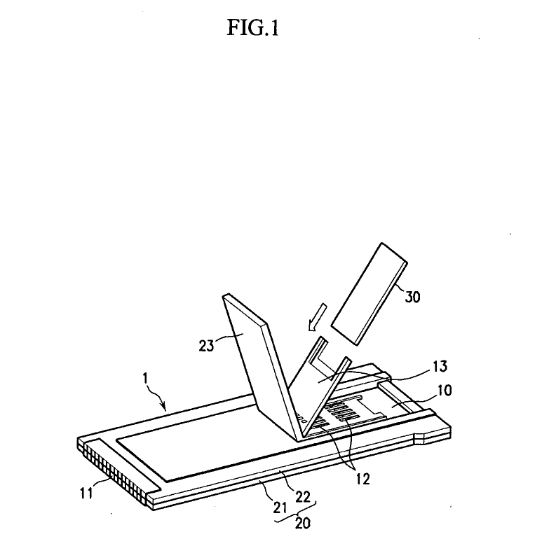

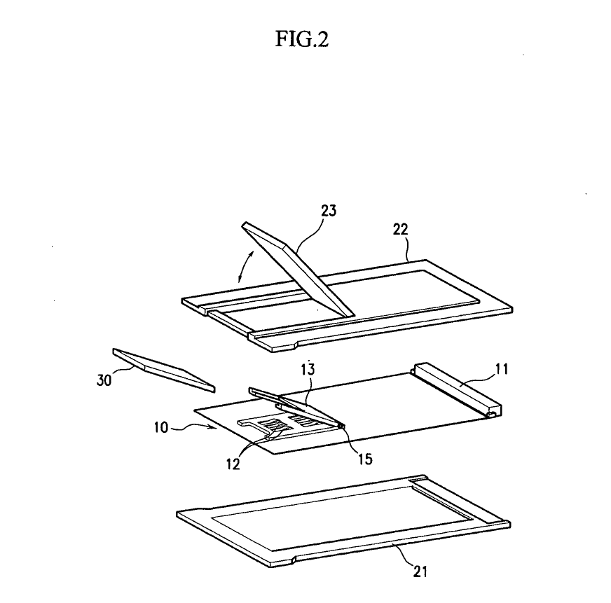

FIG. 1 is a perspective view of a top-loading card adapter according to a first embodiment of the present invention, and FIG. 2 is an exploded perspective view of the top-loading card adapter according to the first embodiment of the present invention.

The card adapter 1 includes a printed circuit board 10 having a connector 11 for external connection at one end thereof such that a small-sized chip type smart card 30 (hereinafter, referred to as a card) is connected to a connector of an electronic equipment, such as a set-top box, standardized according to the PCMCIA standard, and a plug-in card housing 20 for accommodating the printed circuit board 10 therein, and for exposing and fixing the connector 11 at one side thereof.

Here, the card 30 is a SIM (Subscriber Identification Module) card, and the connector 11 and the housing 20 conform to the PCMCIA standard.

The printed circuit board 10 includes a plurality of contact elements 12 which are electrically contacted with the circuit device of the card 30, and a card holder 13 for inserting and fixing the card 30 such that the card 30 is contacted with the contact elements 12 at the upper side thereof.

Since the location of the contact elements 12 formed on the printed circuit board 10 can be more freely selected, compared with the conventional smart card in which the location of the circuit device is standardized, the size of the printed circuit board 10, the locations of the components including a CPU (Central Processing unit), and the structure of the circuit can be freely set.

The card holder 13 is formed with the slide-in slit having an inner accommodating channel between two fixing plates such that the card 30 can be inserted and fixed at the front side.

At this time, one end of the card holder 13 is rotatably hinge-coupled to one end of the contact elements 12 of the printed circuit board 10 such that the card 30 can be more easily inserted and separated.

Also, the housing 20 is composed of a lower cover plate 21 and an upper cover plate 22 that are coupled through the printed circuit board 10. These plates may be integrally formed by molding the outside of the printed circuit board 10 by plastic.

Here, since only a portion of the inner accommodating space of the housing 20 is used as the space for accommodating the card 30, the size of the components mounted on the print circuit board 10 can be freely selected.

The upper cover plate 22 includes an opening in the upper side corresponding to the card holder 13, and the card is inserted into, and separated from, the opening. Further, the upper cover plate 22 includes a door 23 for opening and closing the opening.

The door 23 is rotatably hinge-coupled to one side of the opening of the upper cover plate 22 such that the upper side corresponding to the card holder 13 can be opened and closed.

Accordingly, since the card 30 is inserted into, and fixed to, the card holder 13, to be contacted with the contact elements of the printed circuit board 10 accommodated in the housing 20 through the opening opened by the door 23, the card is not easily separated. Accordingly, the card is prevented from being lost or damaged and malfunction due to contact failure with the contact elements 12 can be efficiently prevented.

Also, a locking means (not shown) using elastic deformation, such as a locking jaw, may be provided at the end of the opening side of the door 23 such that a closed state of the door 23 can be maintained.

Hereinafter, other embodiments of the top-loading card adapter of the present invention will be described with reference to the accompanying drawings. Parts that are the-same as in the first embodiment use the same reference numerals, and their description will be omitted.

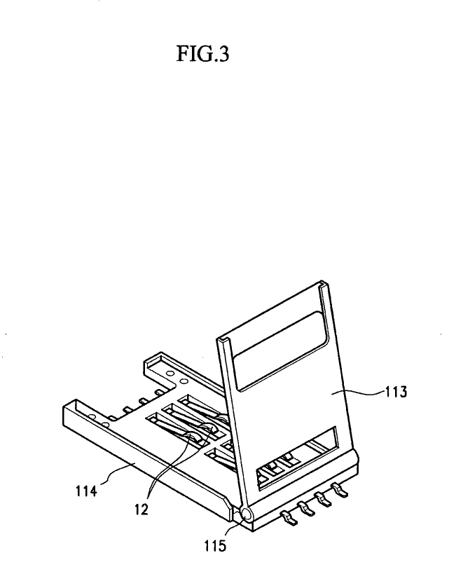

FIG. 3 is a perspective view of a unit assembly of combining a card holder and an insulating substrate on which contact elements are formed in a top-loading card adapter according to a second embodiment of the present invention.

The contact elements 12 may be directly formed on the printed circuit board 10 by patterning. Also, the contact elements 12 may be separately formed on the insulating substrate 114, and the insulating substrate 114 may be fixed to the printed circuit board 10 such that the contact elements 12 compose the circuit of the printed circuit board 10.

In the case of forming the contact elements 12 on the insulating substrate 114 independent of the printed circuit board 10, the card holder 113 is rotatably hinge-coupled to one side of the insulating substrate 114 to form a unit assembly which can be separated from the printed circuit board 10.

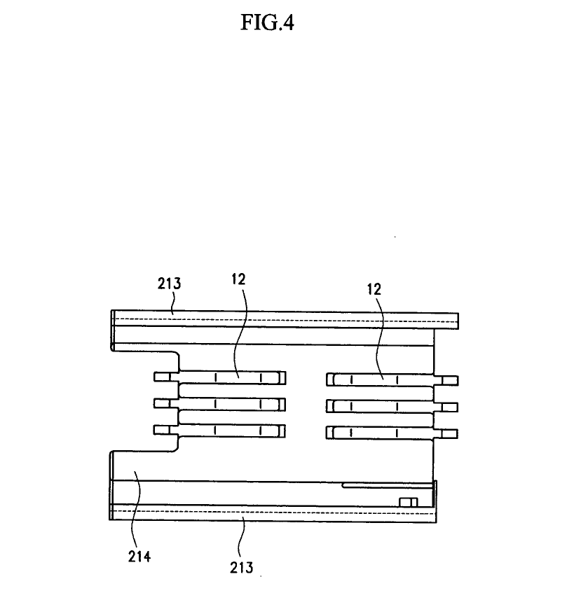

FIG. 4 is a plan view of an insulating substrate on which contact elements and a card holder are integrally formed in a top-loading card adapter according to a third embodiment of the present invention.

The card holder 213 includes at least a pair of guide projections which are formed along both sides opposed to each other through the contact elements 12 formed on the printed circuit board 10, or more preferably, on the insulating element 214.

Accordingly, the guide projection can simplify the structure of the card holder 213 since it guides the card 30 such that the card 30 is inserted and fixed while being electrically contacted with the contact elements 12.

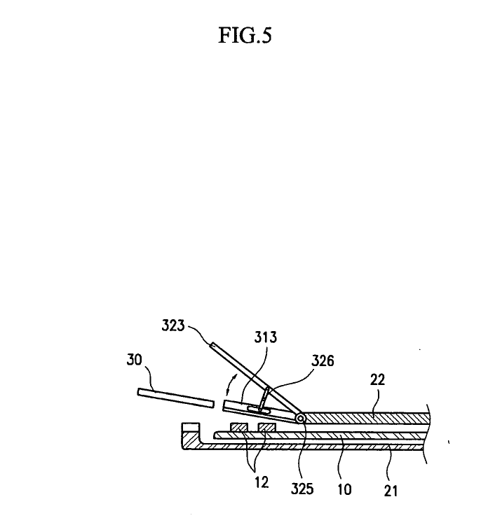

FIG. 5 is a partial side view of a top-loading card adapter according to a fourth embodiment of the present invention.

The card holder 313 is independently and rotatably hinge-coupled (325) to the axis to which the door 323 is hinge-coupled at one side of the opening of the upper cover plate 22.

Accordingly, the card holder 313 is prevented from being directly or indirectly fixed to the printed circuit board 10, which has weak durability.

At this time, in order to easily insert or separate the card 30, it is preferable that the card holder 313 is link-coupled (326) to the door 323 such that it is opened and closed together with the door 32 with a constant phase difference.

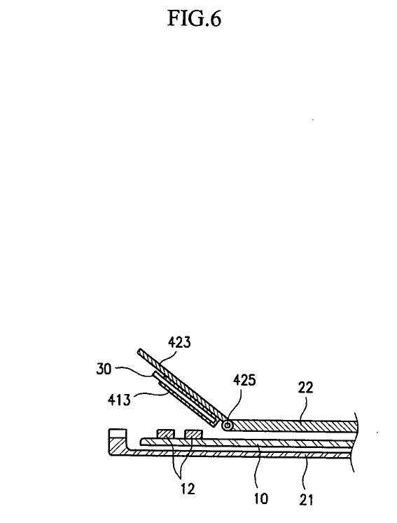

FIG. 6 is a partial side view of a top-loading card adapter according to a fifth embodiment of the present invention.

The card holder 413 for inserting and fixing the card 30 is integrally formed on the inside of the door 423 opposite to the contact elements 12 when closing the door 423.

Accordingly, when opening the door 423, inserting the card 30 into the card holder 413, and closing the door 423, the card 30 inserted into the card holder 13 is automatically contacted with the contact elements 12.

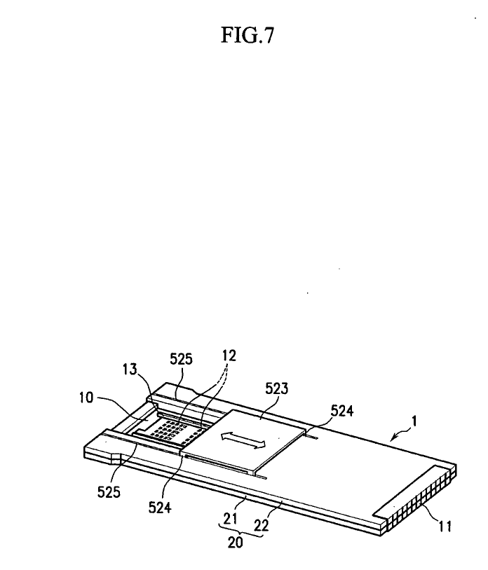

FIG. 7 is a perspective view of a top-loading card adapter according to a sixth embodiment of the present invention.

Guide rails 525 are provided along both sides of the opening of the upper cover plate 22 such that the door 523 is slid to open or close the opening of the upper cover plate 22, and a slider 524 is extended at each edge of the door 523. Accordingly, the door 523 allows the slider 524 to be slid along the guide rail 525 to open or close the opening.

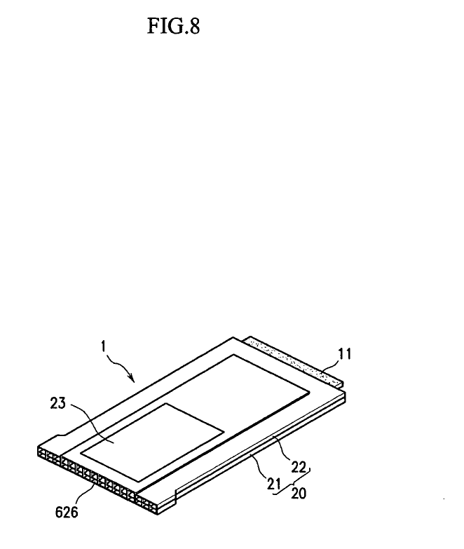

FIG. 8 is a perspective view of a modification of a housing in the top-loading card adapter according to the first embodiment of the present invention.

In the housing 20, plural ventilation holes 626 for cooling the heating components mounted on the printed circuit board 10 are formed at the side opposite to the connector 11, in which the slide-in slit for inserting the smart card was conventionally formed. This structure can be applied to every embodiment.

Also, it is preferable that the printed circuit board 10 is designed so that the heating components, including the CPU, are arranged at the location adjacent to the ventilation holes 626.

As mentioned above, according to the card adapter of the present invention, the small-sized chip type smart card can be loaded at the upper side of a module to be connected to the connector of the electronic equipment standardized according to the PCMCIA standard.

Also, by inserting and fixing the small-sized chip type smart card into the housing by the card holder, loss and damage of the card due to separation of the card can be prevented and malfunction due to contact failure can also be prevented.

Moreover, the location of the contact elements corresponding to the small-sized chip type smart card can be freely set so that the circuit device of the printed circuit board and the components can be freely arranged.

Also, the inner space for accommodating the small-sized chip type smart card in the housing can be reduced so that the components embedded therein can be freely selected.

Although exemplary embodiments of the present invention have been described, the present invention is not limited to the exemplary embodiments, but may be modified in various forms without departing from the scope of the appended claims, the detailed description, and the accompanying drawings of the present invention. Therefore, it is natural that such modifications belong to the scope of the present invention.

1. A card adapter comprising:
a printed circuit board with a connector adapted for being removably connected to an external data processing apparatus at one end thereof;
a housing for accommodating the printed circuit board therein, and for exposing and fixing the connector at one side thereof
contact elements arranged adjacent to an end opposite to the side at which the connector of the printed circuit board is provided and electrically connected with a circuit device of the printed circuit board; and
a card holder fixed adjacent to the contact elements such that the card may be inserted into, and fixed to, the holder to be electrically contacted with the contact elements,
the housing further having an opening on the upper side corresponding to the card holder such that the card can be inserted or separated through the opening.

2. The card adapter of claim 1, wherein the card holder is formed with a slide-in slit and is rotatably hinge-coupled to the printed circuit board at one side of the contact elements.

3. The card adapter of claim 1, wherein the card holder comprises at least a pair of guide projections formed along both sides that are opposed to each other through the contact elements on the printed circuit board.

4. The card adapter of claim 1, wherein the contact elements are formed on an insulating substrate, which is formed independent of the printed circuit board, and the card holder is fixed on the insulating substrate.

5. The card adapter of claim 1, wherein the housing comprises a door for opening and closing the opening.

6. The card adapter of claim 5, wherein the door is hinge-coupled to the housing.

7. The card adapter of claim 5, wherein the door is coupled to slidingly open and close the opening of the housing.

8. The card adapter of claim 6, wherein the card holder is independently and rotatably hinge-coupled to the axis to which the door is hinge-coupled.

9. The card adapter of claim 8, wherein the card holder is link-coupled such that it is opened together with the door with a constant phase difference.

10. The card adapter of claim 5, wherein the door is integrally formed with the card holder at the inner side thereof.

11. The card adapter of claim 1, wherein the connector and the housing conform to the PCMCIA (Personal Computer Memory Card International Association) standard.

12. The card adapter of claim 1, wherein the card comprises a SIM (Subscriber Identification Module) card.

13. The card adapter of claim 1, wherein a CPU (Central Processing Unit) is mounted on the printed circuit board adjacent to the side opposite to the side at which the connector is formed.

14. The card adapter of claim 1, wherein the housing includes a ventilation hole which is formed at the side opposite to the side to which the connector is fixed.

15. The card adapter of claim 1, wherein the housing is integrally formed by molding the outside of the printed circuit board.
